(19) United States
(12) Patent Application Publication
(10) Pub. No.: US 2010/0060595 A1
(43) Pub. Date: Mar. 11, 2010

(54) MOBILE TERMINAL AND METHOD OF SWITCHING IDENTITY MODULE THEREIN

(75) Inventors: Jung Hun LEE, Seoul (KR); Moosung KIM, Seoul (KR); Yoomee SONG, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/407,688

(22) Filed: Mar. 19, 2009

(30) Foreign Application Priority Data
Sep. 5, 2008 (KR) 10-2008-0087546

(51) Int. Cl. G06F 3/041; H04M 1/00

(52) U.S. Cl. 345/173; 455/566

(57) ABSTRACT

A mobile terminal includes a plurality of identity modules, a touch screen configured to display a list including a plurality of service items, the list indicating an assigned identity module, of the plurality of identity modules, for each of the plurality of service items, and a controller configured to switch the assigned identity module of a first service item of the plurality of service items to a different one of the plurality of identity modules responsive to a first touch input that is associated with the first service item.

### CROSS-REFERENCE TO RELATED APPLICATIONS

Pursuant to 35 U.S.C. §119(a), this application claims the benefit of earlier filing date and right of priority to Korean Application No. 10-2008-0087546, filed on Sep. 5, 2008, the contents of which are hereby incorporated by reference herein in their entirety.

### FIELD OF THE INVENTION

The present invention relates to a method of switching an identity module in a mobile terminal. In particular, the mobile terminal can switch the identity module by a touch operation on a touch screen.

### DISCUSSION OF THE RELATED ART

A terminal, such as a personal computer (PC), a notebook computer, and a mobile phone, may have various functions and can be embodied as a multimedia player to perform the various functions. The various functions may include complex functions such as photographing of a picture or a moving picture, reproducing a music file or a moving picture file, playing a game, and receiving broadcasting.

The terminal is divided into a mobile terminal and a stationary terminal according to its mobility. The mobile terminal is divided into a handheld terminal and a vehicle mountable terminal according to its portability.

Nowadays, as various terminals provide the above mentioned complex functions, a user interface (UI) for menu display and list display may be complicated. For example, a mobile terminal in which two subscriber identity module (SIM) cards may be mounted provides a function for selectively connecting a mobile communication network using one of two phone numbers. However, a structure of the phone number list may be complicated when displaying a phone number search window because identification display of two SIM cards should be performed separately in each of phone number lists. Due to such a complicated user interface, it may be difficult for the user to use a function provided by the mobile terminal.

Moreover, the mobile terminal generally has a small screen size. Therefore, a user interface displayed in a small display screen of the mobile terminal should be designed in consideration of convenience and sensitive aspect for simple and easy selection of a function or an instruction to execute a desired operation.

### SUMMARY OF THE INVENTION

In accordance with an embodiment, a method for switching an identity module in a mobile terminal having a touch screen includes displaying a list including a plurality of service items on the touchscreen, indicating an assigned identity module, of a plurality of identity modules, for each of the plurality of service items, and switching the assigned identity module of a first service item of a plurality of service items to a different one of the plurality of identity modules responsive to a first touch input that is associated with the first service item.

In accordance with an embodiment, a method of switching an identity module in a mobile terminal having a touch screen includes displaying a list including a plurality of service items on the touch screen, indicating an assigned identity module, of a plurality of identity modules, for each of the plurality of service items, switching the assigned identity module of a first service item of the plurality of service items to a different one of the plurality of identity modules responsive to a first touch input that is associated with the first service item, and executing an operation related to the first service item responsive to receiving a second touch input.

In accordance with an embodiment, a mobile terminal includes a plurality of identity modules, a touch screen configured to display a list including a plurality of service items, the list indicating an assigned identity module, of the plurality of identity modules, for each of the plurality of service items, and a controller configured to switch the assigned identity module of a first service item of the plurality of service items to a different one of the plurality of identity modules responsive to a first touch input that is associated with the first service item.

These and other embodiments will also become readily apparent to those skilled in the art from the following detailed description of the embodiments having reference to the attached figures, the invention not being limited to any particular embodiment disclosed.

### BRIEF DESCRIPTION OF THE DRAWINGS

The above and other aspects, features, and advantages of the exemplary embodiment will become more apparent upon consideration of the following description of preferred embodiments, taken in conjunction with the accompanying drawings.

FIG. 1 is a block diagram illustrating a configuration of a mobile terminal according to an embodiment of the present invention.

FIGS. 2A and 2B are front and rear perspective views, respectively, of a mobile terminal according to an embodiment of the present invention.

FIG. 3 is a flowchart illustrating switching an identity module according to an embodiment of the present invention.

FIG. 4 is a screen view of a display in a mobile terminal according to an embodiment of the present invention and illustrates manipulating a user interface of the mobile terminal to switch the identity module as described in FIG. 3.

FIG. 5 is a screen view of a display in a mobile terminal according to an embodiment of the present invention and illustrates manipulating a user interface of the mobile terminal to switch an identity module.

FIG. 6 is a screen view of a display in a mobile terminal according to an embodiment of the present invention and illustrates manipulating a user interface of the mobile terminal to switch an identity module.

FIG. 7 is a flowchart illustrating switching an identity module according to an embodiment of the present invention.

FIG. 8 is a screen view of a display in a mobile terminal according to an embodiment of the present invention and illustrates manipulating a user interface of the mobile terminal to switch the identity module as described in FIG. 7.

FIG. 9 is a flowchart illustrating switching an identity module according to an embodiment of the present invention.

FIGS. 10A to 12B are screen views of a display in a mobile terminal according to an embodiment of the present invention and illustrate manipulating a user interface of the mobile terminal to switch the identity module as describe in FIG. 9.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

Preferred embodiments of a mobile terminal are described hereinafter in detail with reference to the drawings. In the following description, suffixes “module” and “unit” of constituent elements are given or used for easily describing a specification, instead of having a distinctive meaning or function. According to an embodiment of the present invention, the mobile terminal may include a mobile phone, a smart phone, a laptop computer, a digital broadcasting terminal, a personal digital assistant (PDA), a portable multimedia player (PMP), and a navigation terminal.

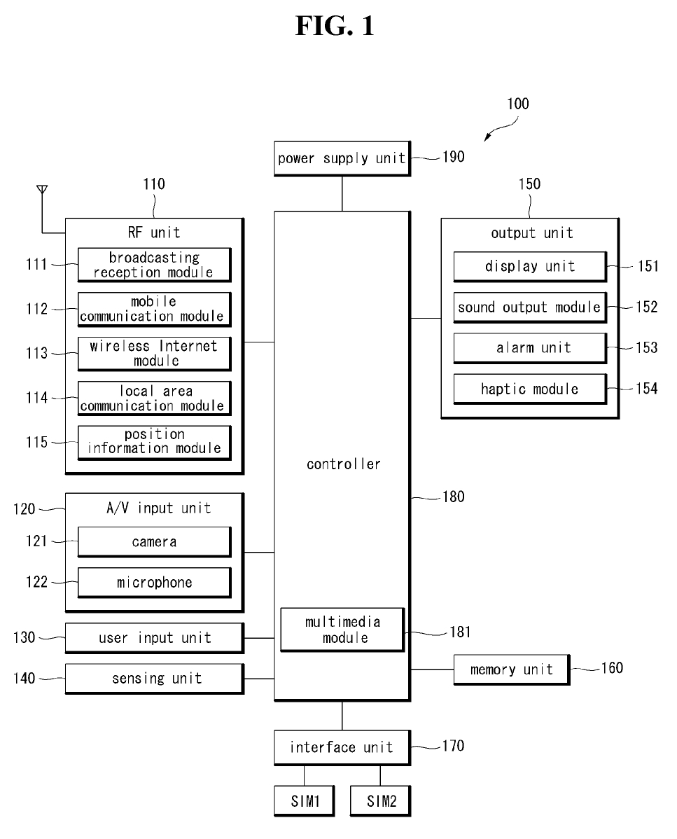

Referring to FIG. 1, a mobile terminal 100 includes a radio frequency (RF) unit 110, an audio/video (A/V) input unit 120, a user input unit 130, a sensing unit 140, an output unit 150, a memory unit 160, an interface unit 170, a controller 180, and a power supply unit 190. All constituent elements shown in FIG. 1 may not be essential and a mobile terminal having more or less elements than those shown in FIG. 1 may be embodied.

The elements are described hereinafter in detail. The RF unit 110 includes one or more module for allowing wireless communication between the mobile terminal 100 and a wireless communication system or between networks at which the mobile terminals 100 are positioned. For example, the RF unit 110 includes a broadcasting reception module 111, a mobile communication module 112, a wireless Internet module 113, a local area communication module 114, and a position information module 115.

The broadcasting reception module 111 receives a broadcasting signal and/or broadcasting related information from an external broadcasting management server through a broadcasting channel. The broadcasting channel includes a satellite channel and a terrestrial channel. The broadcasting management server is a server for generating and transmitting a broadcasting signal and/or broadcasting related information, or a server for receiving the generated broadcasting signal and/or the broadcasting related information and transmitting the generated broadcasting signal and/or the broadcasting related information to the terminal. The broadcasting signal includes a television (TV) broadcasting signal, a radio broadcasting signal, a data broadcasting signal, and may include a broadcasting signal in which a data broadcasting signal is coupled to the TV broadcasting signal and the radio broadcasting signal.

The broadcasting related information may be information related to a broadcasting channel, a broadcasting program, or a broadcasting service provider. The broadcasting related information may be provided through a mobile communication network. In this case, the broadcasting related information may be received by the mobile communication module 112. The broadcasting related information may exist in various forms. For example, the broadcasting related information may exist in a form of an electronic program guide (EPG) of digital multimedia broadcasting (DMB), or an electronic service guide (ESG) of digital video broadcast-handheld (DVB-H).

The broadcasting reception module 111 receives a broadcasting signal using various broadcasting systems and may receive a digital broadcasting signal using a digital broadcasting system such as digital multimedia broadcasting-terrestrial (DMB-T), digital multimedia broadcasting-satellite (DMB-S), media forward link only (MediaFLO), digital video broadcast-handheld (DVB-H), and integrated services digital broadcast-terrestrial (ISDB-T). The broadcasting reception module 111 may be suitably formed for other broadcasting systems for providing a broadcasting signal as well as the above-described digital broadcasting system. A broadcasting signal and/or broadcasting related information received through the broadcasting reception module 111 may be stored in the memory unit 160.

The mobile communication module 112 transmits and receives a wireless signal to and from at least one of a base station, an external terminal, and a server through a mobile communication network. The wireless signal may include data of various forms according to transmission and reception of an audio dedicated call signal, an audiovisual communication call signal, or a character/multimedia message.

The wireless Internet module 113 is a module for connecting to wireless Internet and may be provided at the inside or the outside of the mobile terminal 100. A wireless Internet technology includes wireless LAN (WLAN) (Wi-Fi), wireless broadband (Wibro), world interoperability for microwave access (Wimax), high speed downlink packet access (HSDPA), and the like.

The local area communication module 114 is a module for local area communication. A local area communication technology includes Bluetooth, radio frequency identification (RFID), infrared data association (IrDA), ultra wideband (UWB), ZigBee, and the like.

The position information module 115 is a module for determining or checking a position of a mobile terminal 100. A representative position information module is a global position system (GPS) module. According to a current technology, the GPS module 115 calculates information about a distance in which one point (individual) is separated from three or more satellites and calculates three-dimensional position information according to a latitude, a longitude, and an altitude of one point (individual) at one time point by calculating information about a time point in which the distance information is measured and applying trigonometry to the calculated distance information. Further, the GPS module 115 uses a method of calculating position and time information using three satellites and modifying an error of the calculated position and time information using another satellite. The GPS module 115 continues to calculate a current position in real time and may calculate speed information using the calculated position information.

The A/V input unit 120 is used for inputting an audio signal or a video signal and includes a camera 121 and a microphone 122. The camera 121 processes an image frame of a still picture or a moving picture obtained by an image sensor in an audiovisual communication mode or a photographing mode. The processed image frame is displayed by the display unit 151.

The image frame processed in the camera 121 is stored in the memory unit 160, or is transmitted to the outside through the RF unit 110. Depending on a configuration of the terminal, two or more cameras 121 may be provided.

The microphone 122 is used for inputting an external sound signal in a communication mode, a recording mode, or a voice recognition mode and processes the external sound signal to electrical voice data. The processed voice data are switched to a form that can transmit to a mobile communication base station through the mobile communication module 112 and are output in the communication mode. Various noise removal algorithms for removing noise generated when inputting an external audio signal may be used in the microphone 122.

The user input unit 130 is used by the user for inputting data for controlling an operation of the mobile terminal 100. The user input unit 130 includes a keypad, a dome switch, a touch pad (static pressure/electrostatic), a jog wheel, and a jog switch.

The sensing unit 140 detects a current state of the mobile terminal 100 such as an opening or closing state of the mobile terminal 100, a position of the mobile terminal 100, a contact state of the user, an orientation of the mobile terminal 100, and acceleration/deceleration of the mobile terminal 100 and generates a sensing signal for controlling an operation of the mobile terminal 100. For example, when the mobile terminal 100 is configured as a slide phone form, the sensing unit 140 detects an opening or a closing state of the slide phone. Further, the sensing unit 140 may perform a sensing function related to the power supply of the power supply unit 190 and coupling of external appliances to the interface unit 170. The sensing unit 140 may include a proximity sensor.

The output unit 150 is used for generating the output related to a visual sense, an auditory sense, or a tactile sense and includes a display unit 151, a sound output module 152, an alarm unit 153, and a haptic module 154.

The display unit 151 displays information processed in the mobile terminal 100. For example, when the mobile terminal 100 is in a communication mode, the display unit 151 displays an UI or a graphic user interface (GUI) related to communication. When the mobile terminal 100 is in an audiovisual communication mode or a photographing mode, the display unit 151 displays a photographed and/or received image, the UI, or the GUI.

The display unit 151 includes at least one of a liquid crystal display (LCD), a thin film transistor-liquid crystal display (TFT LCD), an organic light-emitting diode (OLED), a flexible display, and a three-dimensional display (3D display). Some display thereof may be formed in a transparent type or a light transmitting type in order to view the outside through the display, and this is called a transparent display. A representative transparent display is a transparent LCD. A rear structure of the display unit 151 may be formed in a light transmitting structure. By such a structure, the user can view an object positioned at the rear side of a terminal body through an occupying area of the display unit 151 in the terminal body.

The mobile terminal 100 may be configured to have two or more display units 151. For example, in the mobile terminal 100, a plurality of display units 151 may be disposed apart or integrally in one surface, or each may be disposed in different surfaces.

When the display unit 151 and a sensor such as a touch sensor for detecting a touch operation form an interlayer structure, the combined form is referred to as a touch screen and the display unit 151 may be used as an input device in addition to an output device. The touch sensor may have a form of, for example, a touch film, a touch sheet, and a touch pad.

The touch sensor may switch the change of a pressure applied to a specific portion of the display unit 151 or a capacitance generated in a specific portion of the display unit 151 to an electrical input signal. The touch sensor can detect a pressure upon touching as well as a touched position and a touched area.

When touch input is detected by the touch sensor, a signal corresponding to the touch input is sent to a touch controller. The touch controller processes the signal and transmits the corresponding data to the controller 180. Thereby, the controller 180 determines a touch area of the display unit 151, determines a long touch or a short touch by counting a touch time period, and determines a touch form of dragging or flicking.

A proximity sensor may be disposed in an inner area of the mobile terminal 100 surrounded by the touch screen or around the touch screen. The proximity sensor is a sensor for detecting an object approaching a predetermined detection surface, or an object existing in a periphery without a mechanical contact using a force of an electromagnetic field or infrared rays (IR). The proximity sensor may have a life-span longer than that of a touch sensor and may be used more widely than the touch sensor.

Examples of the proximity sensor are a transmissive photoelectric sensor, a direct reflective photoelectric sensor, a mirror reflective photoelectric sensor, a high frequency oscillation proximity sensor, a capacitance proximity sensor, a magnetic proximity sensor, and an infrared rays proximity sensor.

When the touch screen is an electrostatic type, the touch screen detects the approach of the pointer using the change of an electric field according to the approach of the pointer. In this case, the touch screen (touch sensor) may be classified as a proximity sensor.

The proximity sensor detects a proximity touch and a proximity touch pattern, for example, a proximity touch distance, a proximity touch direction, a proximity touch speed, a proximity touch time period, a proximity touch position, and a proximity touch moving state. Information corresponding to the detected proximity touch operation and proximity touch pattern is output on the touch screen.

The sound output module 152 may output audio data received from the RF unit 110 or stored in the memory unit 160 in a call signal reception mode, a communication mode or a recording mode, a voice recognition mode, and a broadcasting reception mode. The sound output module 152 outputs a sound signal related to a function, for example, a call signal reception sound and a message reception sound performed in the mobile terminal 100. The sound output module 152 may include a receiver, a speaker, and a buzzer.

The alarm unit 153 outputs a signal for notifying occurrence of an event in the mobile terminal 100. Events occurred in the mobile terminal 100 includes, for example, reception of a call signal, reception of a message, input of a key signal, and input of a touch. The alarm unit 153 may output other forms, for example, a signal for notifying occurrence of an event using a vibration, in addition to a video signal or an audio signal. The video signal or the audio signal may be output through the display unit 151 or the sound output module 152.

The haptic module 154 generates various haptic effects in which the user can feel. A representative haptic effect generated by the haptic module 154 is a vibration. Intensity and a pattern of a vibration generated by the haptic module 154 can be controlled. For example, the haptic module 154 may synthesize and output different vibrations or sequentially output different vibrations.

The haptic module 154 may generate various haptic effects such as a stimulation effect due to arrangement of pins moving vertically to a skin contact surface, a stimulation effect due to an ejection force or a suction force of air through an ejection device or a suction device, a stimulation effect due to a touch of a skin surface, a stimulation effect due to a contact of an electrode, a stimulation effect due to use of an electrostatic force, and an effect due to reproduction of a cold and warm feeling using a heat-absorbing element or a heat-emitting element, in addition to a vibration.

The haptic module 154 may transmit a haptic effect through a direct touch and allow to feel a haptic effect through a muscle sense of a user's finger or arm. According to a configuration of the mobile terminal 100, two or more haptic modules 154 may be provided.

The memory unit 160 stores a program for operating the controller 180 and may temporarily store input/output data such as a phonebook, a message, a still picture, and a moving picture. The memory unit 160 may store data about a vibration and sound of various patterns to be output when the touch screen is touched.

The memory unit 160 may include at least one storage medium of a flash memory type, a hard disk type, a multimedia card micro type, a card type memory (for example, a secure digital (SD) memory or an extreme digital (XD) memory), a random access memory (RAM), a static random access memory (SRAM), a read-only memory (ROM), an electrically erasable programmable read-only memory (EEPROM), a programmable read-only memory (PROM), a magnetism memory, a magnetic disk, and an optical disk. The mobile terminal 100 may use web storage for performing a storage function of the memory unit 160 via the Internet.

The interface unit 170 functions as a passage of all external appliances connected to the mobile terminal 100. The interface unit 170 receives data or power from external appliances to transmit the data or the power to constituent elements within the mobile terminal 100, or transmits data within the mobile terminal 100 to the external appliances. The interface unit 170 may include, for example, a wired/wireless headset port, an external charger port, a wired/wireless data port, a memory card port, an identity module port, an audio input/output (I/O) port, a video I/O port, and an earphone port.

The identity module is a chip for storing various information for certifying user authority of the mobile terminal 100 and may include an UIM, a SIM, and an USIM. An identity device in which the identity module is provided may be manufactured in a smart card form. Therefore, the identity device can be connected to the mobile terminal 100 through a port. In the identity module, a phone number, communication information, accounting information, and the like are stored.

The mobile terminal 100 may detachably mount two or more identity modules and select an identity module for connecting to a mobile communication network by switching the identity module as described below. While FIG. 1 illustrates the identity module as SIM 1 and SIM 2, other identity modules such as the UIM or the USIM may be connected to the mobile terminal 100 through the interface unit 170.

When the mobile terminal 100 is connected to an external cradle, the interface unit 170 may be a passage for supplying power from the cradle to the mobile terminal 100, or a passage for transmitting various instruction signals input to the cradle by the user to the mobile terminal 100. Various instruction signals or power input from the cradle may be operated as a signal for notifying that the mobile terminal 100 is accurately mounted in the cradle.

The controller 180 controls general operations of the mobile terminal 100. For example, the controller 180 performs the control and a processing related to audio dedicated communication, data communication, and audiovisual communication. The controller 180 may include a multimedia module 181 for reproducing multimedia. The multimedia module 181 may be provided within the controller 180 or be separately provided from the controller 180.

The controller 180 can be embodied with a chip for selecting one of a plurality of identity modules using a switch means of an interface and may be embodied with a master chip and a slave chip in order to connect in a relationship of one to one in a plurality of identity modules. The master chip and the slave chip may be connected to a separate RF unit 110. Some configuration of the RF unit 110 connected to the slave chip may be omitted, and when a function of the omitted configuration is necessary, the slave chip is connected to the RF unit 110 connected to the master chip via the master chip and may provide a function of the omitted configuration. The master chip and the slave chip can be selectively connected to two identity modules through the interface unit 170.

The controller 180 can perform a pattern recognition processing that can recognize hand writing input or drawing input performed on the touch screen as a character and an image, respectively. Further, the controller 180 can detect a touch time period to a touch screen by counting a clock from an internal oscillator.

The power supply unit 190 receives external power and internal power by the control of the controller 180 to supply power necessary for operating constituent elements.

Various embodiments described here can be embodied within a record medium that can read with a computer or a device similar thereto using, for example, software, hardware, or a combination thereof. When embodied with hardware, an embodiment described here can be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and an electric unit for performing a function. In some cases, the embodiments can be embodied by the controller 180.

When embodied with software, embodiments such as a procedure or a function can be embodied together with a separate software module for performing at least one function or operation. A software code can be embodied by a software application written with an appropriate programming language. Further, a software code may be stored in the memory unit 160 and executed by the controller 180.

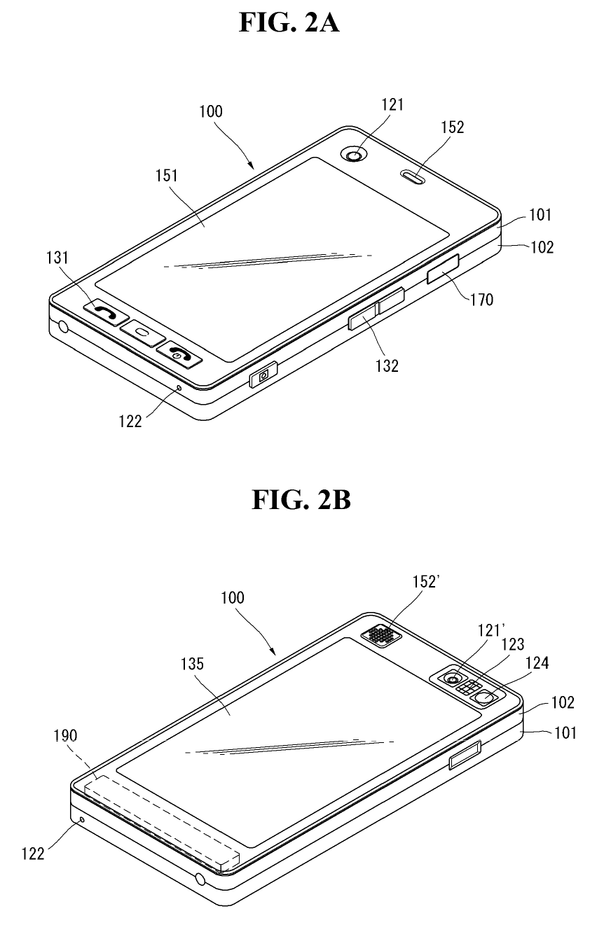

Referring to FIG. 2A, according to an embodiment of the present invention, the mobile terminal 100 has a bar type terminal body. However, the present invention is not limited thereto and may be embodied in various structures such as a slide type, a folder type, a swing type, and a swivel type in which two or more bodies are relative-moveably coupled.

The terminal body includes a case (a casing, a housing, a cover, and the like) for forming an external shape. In the embodiment shown in FIGS. 2A and 2B, the case includes a front case 101 and a rear case 102. Various electronic components are provided in a space formed between the front case 101 and the rear case 102. At least one intermediate case may be additionally disposed between the front case 101 and the rear case 102. The cases are manufactured by injecting a synthetic resin or are made of a metal material such as stainless steel (STS) or titanium (Ti).

In the terminal body, generally, in the front case 101, a display unit 151, a sound output unit 152, a camera 121, user input unit 130 including 131 and 132, a microphone 122, interface 170 may be disposed. The user input units 131 and 132 may include an identity module switching key to be described later.

The display unit 151 occupies most of a main surface of the front case 101. The sound output unit 152 and the camera 121 are disposed in an area adjacent to one of both end parts of the display unit 151, and the user input unit 131 and the microphone 122 are disposed in an area adjacent to the other end thereof. The user input unit 132 and the interface 170 are disposed at side surfaces of the front case 101 and the rear case 102, and some interface such as a port slot of a memory card or an SIM card may be disposed around battery mounting space covered by a front case.

The user input units 131 and 132 are used for inputting an instruction for controlling an operation of the mobile terminal 100 and may include a plurality of manipulation units. The user input units 131 and 132 may be called a manipulation unit or portion and can adapt any tactile manner in which a user can feel conversion of a tactile sense.

Contents input by the user input units 131 and 132 may be variously set. For example, the first user input unit 131 may receive an instruction such as start, end, and scroll, and the second user input unit 132 may receive magnitude adjustment of sound output from the sound output unit 152, or an instruction such as conversion to a touch recognition mode of the display unit 151.

FIG. 2B is a rear perspective view of the mobile terminal 100 shown in FIG. 2A. Referring to FIG. 2B, a camera 121′ may additionally be mounted in a rear surface, i.e. a rear case 102 of a terminal body. The camera 121′ has a photographing direction substantially opposite to that of the front camera 121 shown in FIG. 2A and may have a resolution different from that of the camera 121.

For example, the camera 121 generates a low pixel photograph and is used to transmit a user's face to another party in real time without a trouble during audiovisual communication. In contrast, because an image input via the camera 121′ is not generally directly transmitted, the camera 121′ is preferably configured to produce high pixel photographs of general subjects. The cameras 121 and 121′ may be provided rotatably or can be configured to pop-up in the terminal body.

A flash 123 and a mirror 124 may be additionally provided adjacently to the camera 121′. When photographing a subject using the camera 121′, the flash 123 may emit light toward a subject. When a user photographs a self portrait using the camera 121′, the mirror 124 allows the user to view the user's own face.

A sound output unit 152′ may be additionally disposed at the rear surface of the terminal body. The sound output unit 152′ together with a front sound output unit 152 shown in FIG. 2A may embody a stereo function and be used for embodying a speakerphone mode upon communicating.

In the side surface of the terminal body, an antenna for communication and an antenna for receiving a broadcasting signal may be additionally disposed. An antenna constituting a part of the broadcasting reception module 111 of FIG. 1 may be provided to draw from the terminal body.

In the terminal body, the power supply unit 190 for supplying power to the mobile terminal 100 is mounted. The power supply unit 190 is provided within the terminal body or is provided directly detachably from the outside of the terminal body.

In the rear case 102, a touch pad 135 for detecting a touch is additionally mounted. Like the display unit 151, the touch pad 135 may be formed in a light transmitting type. In this case, if the display unit 151 is formed to output visual information from both surfaces, the visual information can be recognized through the touch pad 135. Information output from both surfaces may be controlled by the touch pad 135. Alternatively, as a display is additionally mounted in the touch pad 135, a touch screen may be disposed even in the rear case 102.

The touch pad 135 may operate cooperatively with the display unit 151 of the front case 101. The touch pad 135 may be disposed in parallel to the rear side of the display unit 151. The touch pad 135 may have a size equal to or smaller than that of the display unit 151.

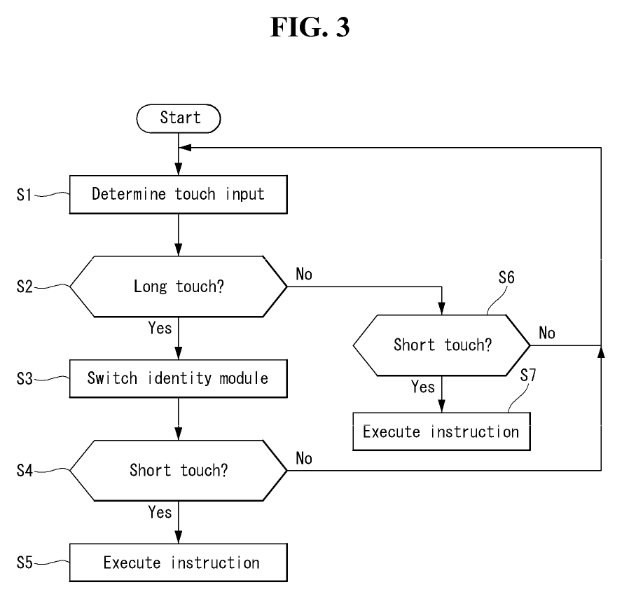

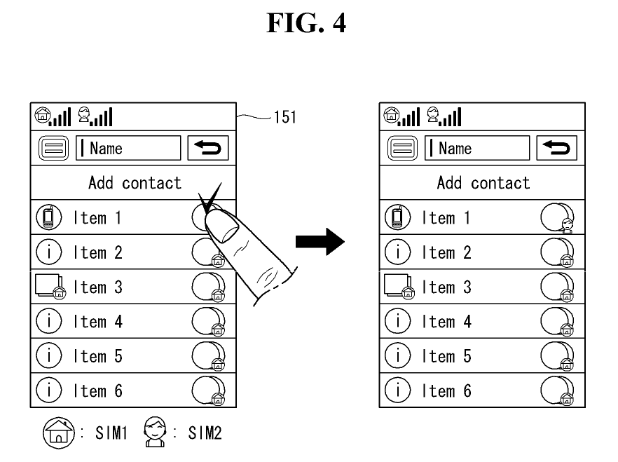

FIG. 3 is a flowchart illustrating switching an identity module in a mobile terminal according to an embodiment of the present invention. FIG. 4 illustrates a user interface manipulated according to the switching method described in FIG. 3.

Referring to FIG. 4, a list, in which items 1 to 6 are arranged, is displayed in the touch screen of the mobile terminal 100. A list displayed on the touch screen is one of a phone number list and a message list and includes items 1 to 6 that can be serviced through a mobile communication network. In the case of the phone number list, items 1 to 6 are displayed with a text, an icon, and the like to indicate a communication path such as a phone number of other subscribers.

In the case of the message list, items 1 to 6 are displayed with a text, an icon, and the like to indicate a message transmission path such as a phone number of another subscriber that can receive a short message service (SMS) message consisting of only a text, a multi-media message service (MMS) message that can attach an image, a picture, a melody, and the like, or an e-mail transmission path such as an uniform resource locator (URL) address of another subscriber that can receive an e-mail through wireless Internet. If in addition to the items currently displayed on the touch screen, as shown in FIG. 4, more items exist in the selected list, a scroll bar is automatically displayed at a portion of the touch screen, preferably on the side of the touch screen.

In each of items 1 to 6 displayed on the list screen, a currently assigned identity module, SIM1 or SIM2, is displayed and an identity module, an instruction icon, and a text that receive a user instruction are displayed at a portion of the screen, for example, on the right side of the screen, as shown in FIG. 4. In FIG. 4, an icon having a house shape indicates a first identification mode (SIM1) and indicates an instruction icon that receives an instruction such as communication and message transmission. An icon having a shape of a person indicates a second identification mode (SIM2) and indicates an instruction icon that receives an instruction such as communication and message transmission.

Further, in each of items 1 to 6 on the list screen, an icon or a text for representing an attribute of the list, for example, a phone number, an MMS, and an SMS is displayed at a portion of the screen, for example, the left side of the screen, as shown in FIG. 4. In FIG. 4, an icon having a shape of a mobile terminal indicates a phone number of another subscriber, and an icon having a shape in which two papers are overlapped indicates a phone number or an URL address to which a message or an e-mail is to be transmitted.

At an uppermost end of the list screen, graphics for representing signal strength of the first identity module (SIM1) and signal strength of the second identity module (SIM2) are respectively displayed, and a search window, for example, a box with “Name” in FIG. 4, is displayed under the uppermost end. In an item “Add contact” of the list, an instruction to add a new contact to the list can be input by the user, and if the user touches the item “add contact,” an item addition menu is displayed. The user can easily switch an identification item by increasing a touch time in a user interface displayed on a touch screen.

A method of switching an identity module according to the flowchart of FIG. 3 can be embodied by a user interface software application executed by the controller 180. Referring to FIGS. 3 and 4, if the user touches an item with a hand or a stylus pen on a touch screen in which the UI of is displayed as shown in FIG. 4, the controller 180 determines the position of a touched item, a touch time period, and a touch form (S1).

The controller 180 determines whether the touch input is a long touch or a short touch depending on the length of the touch period by comparing the length of a touch period to a reference or preset time period (S2). For example, the touch input is determined to be the long touch if the length of the touch period is equal to or longer than the reference time period. If a user's touch is the long touch, the controller 180 switches an identity module of the touched item (S3). For example, as shown in FIG. 4, if the user touches a right icon of the first item “Item 1” for an extended period, as shown on the left panel, the controller 180 switches the identity module of the first item from a first identity module (SIM1) to a second identity module (SIM2), as shown on the right panel.

Thereafter, if the user touches the item for a short period, the controller 180 determines whether the touch time period is a short touch period that is shorter than the reference time period (S4). Upon determining that the touch time period is a short touch period, the controller 180 executes an instruction of the touched item (S5). For example, if a touched item is a phone number item, the controller 180 connects to a mobile communication network and executes audio dedicated communication or audiovisual communication, and if a touched item is a message item, the controller 180 executes a message transmission menu or an e-mail transmission menu according to the user selection. If the user does not touch or the user's touch is not a short touch at S4, the process returns to S1.

If a user's touch is not a long touch at S2, the controller 180 determines whether the user's touch is a short touch (S6). If the user's touch is a short touch, the controller 180 executes the user's instruction in a current identity module, instead of switching the identity module (S7). For example, if the touched item is a phone number item, the controller 180 performs communication by connecting to a mobile communication network, and if the touched item is a message item, the controller 180 executes a message transmission menu or an e-mail transmission menu.

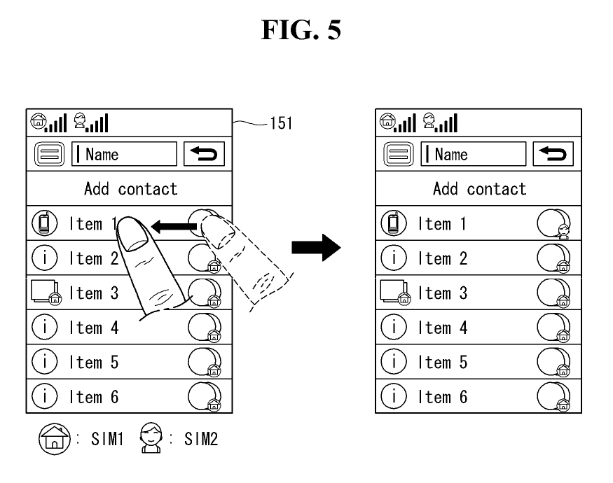

FIG. 5 illustrates manipulating a user interface to switch an identity module according to an embodiment of the present invention. A different type of user input, rather than the long touch recognized in S2 of FIG. 3, may be used to switch the identity module while other control processes for switching the identity module are substantially identical to those of the embodiment described in FIG. 3. For example, if the user drags a finger or a stylus pen at an item displayed on the touch screen at S2, as shown in FIG. 5, the controller 180 determines the recognized dragging input as an identification conversion instruction and switches an identification mode. In the present embodiment, if the user touches an instruction icon of one item for a short period, the controller 180 executes communication or message transmission, as previously described in S4-S7 of FIG. 3.

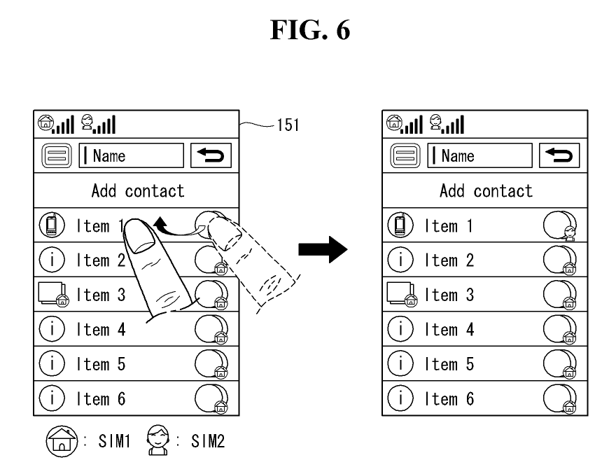

FIG. 6 illustrates manipulating a user interface to switch an identity module according to an embodiment of the present invention. A different type of user input, rather than the long touch recognized in S2 of FIG. 3, may be used to switch the identity module while other control processes for switching the identity module are substantially identical to those of the embodiment described in FIG. 3. For example, if the user flicks a finger or a stylus pen at an item displayed on the touch screen at S2, as shown in FIG. 6, the controller 180 determines the recognized flicking input as an identity conversion instruction and switches the identity module. Here, the flicking input is a type of a touch that moves a finger or a stylus pen in a “U” shape on the touch screen as the user turns over pages of a book. In the present embodiment, if the user touches an instruction icon of one item for a short period, the controller 180 executes communication or message transmission, as previously described in S4-S7 of FIG. 3.

Embodiments described referring to FIGS. 3 to 6 can be simultaneously applied to the mobile terminal 100. For example, if the user performs a long touch, a dragging touch, or a flicking touch on the touch screen at S2, the controller 100 determines the touch input as a conversion instruction of the identity module and switches an identity module to an identity module of the touched item. Further, the controller 100 determines a touch for switching the identity module as a shot touch and determines a touch for executing an instruction as a long touch. That is, in the above described embodiments of the present invention, touch time periods that are different from of the touch time period for an operation or execution of an instruction are determined as a conversion instruction of the identity module while the present invention is not limited to those embodiments.

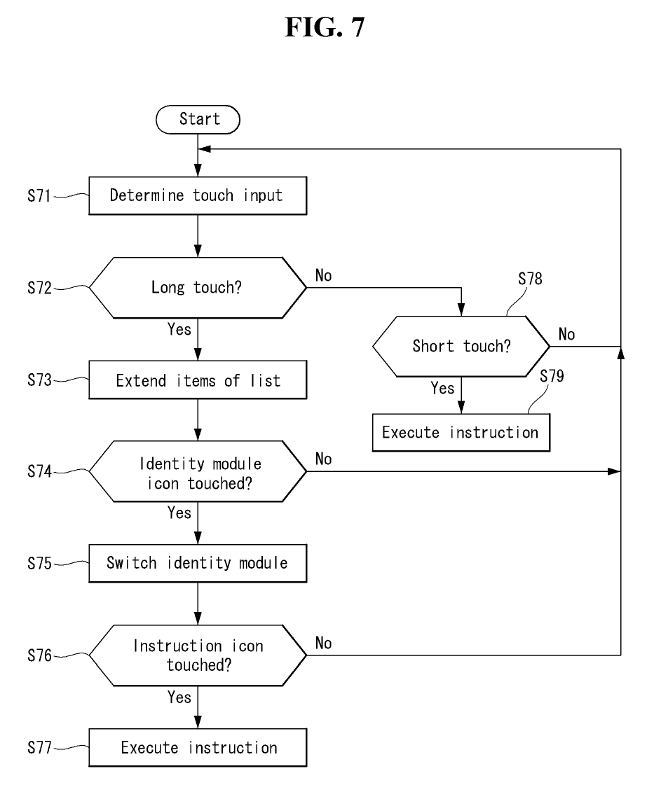

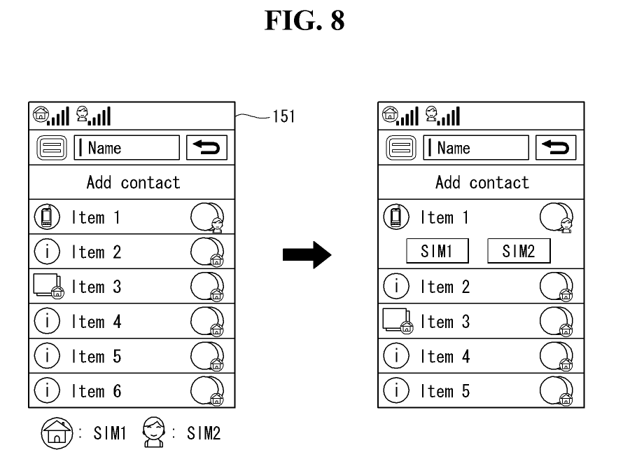

FIG. 7 illustrates switching an identity module according to an embodiment of the present invention. FIG. 8 illustrates manipulating a user interface according to the method described in FIG. 7.

Referring to FIGS. 7 and 8, if the user touches an item with touching object, such as a finger or a stylus pen, on a touch screen in which an UI is displayed as shown in FIG. 8, the controller 180 determines the position of a touched item, a touch time period, and a touch form (S71). The controller 180 determines whether the touch input is a long touch (S72). If the touch input is a long touch, the controller 180 extends the touched item to display more information related to the touched item and switches an icon or a text to an icon or a text for representing each of two identity modules on the extended item (S73). For example, as shown in FIG. 8, if the user touches a right icon of the first item for an extended period, the controller 180 extends the first item to display identity module icons “SIM1” and “SIM2” for representing each of identity modules.

If the user touches one of the displayed identity module icons “SIM1” and “SIM2” (S74), the controller 180 switches an identity module of the touched item to an identity module selected by the user (S75). In this case, the touch input is not limited by a touch time period or a touch form.

Subsequent to switching the identity module, if the user touches an instruction icon, for example, an icon of a house or a person displayed at the right side of a corresponding item (S76), the controller 180 executes an instruction of the touched item (S77). For example, if the touched item is a phone number item, the controller 180 connects to the mobile communication network and executes audio dedicated communication or audiovisual communication, and if the touched item is a message item, the controller 180 executes a message transmission menu or an e-mail transmission menu according to user selection. If the user does not touch or does not touch an instruction icon at S76, the process returns to S71.

If the touch input is not a long touch at S72, the controller 180 executes the user's instruction in a current identity module without extending a list item or switching an identity module (S79). For example, if the touched item is a phone number item, the controller 180 executes communication by connecting to the mobile communication network, and if the touched item is a message item, the controller 180 executes a message transmission menu or an e-mail transmission menu.

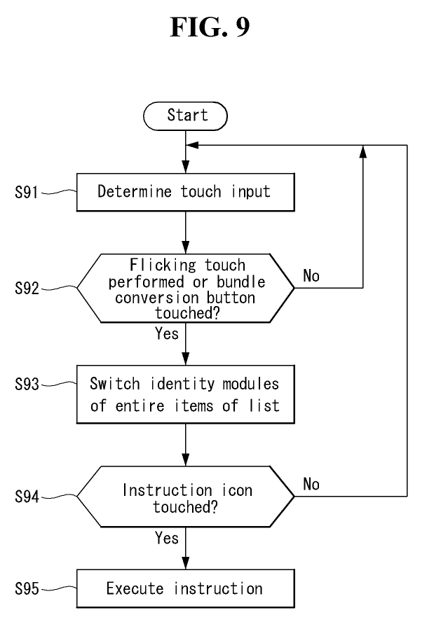

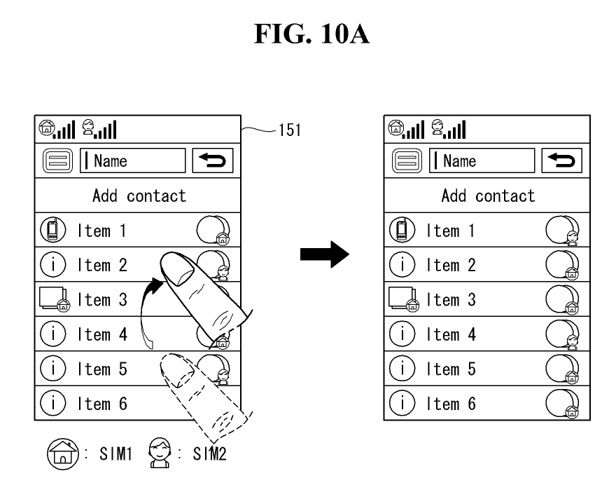

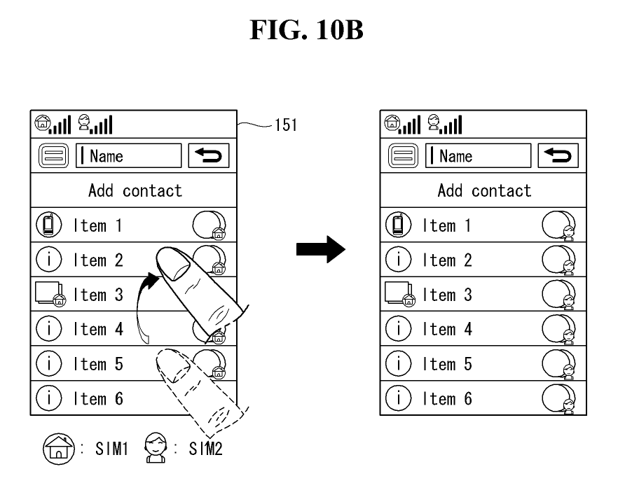

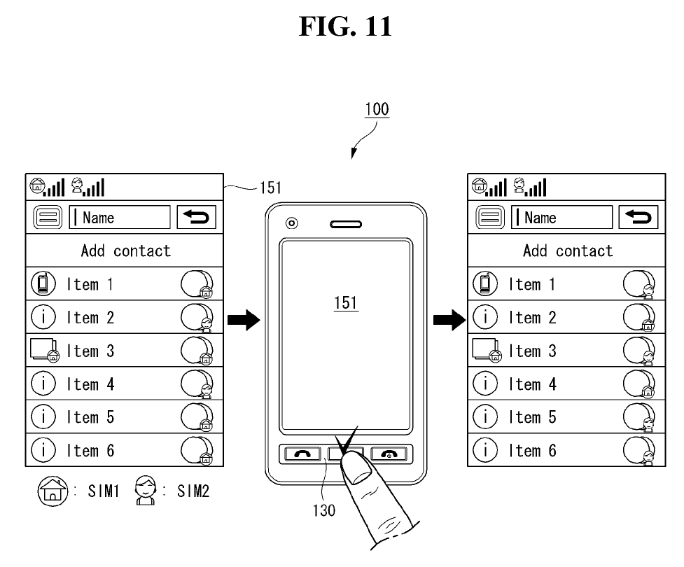

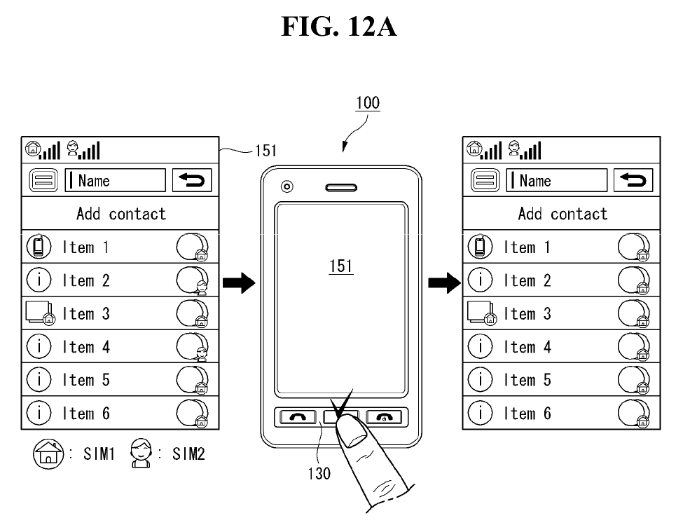

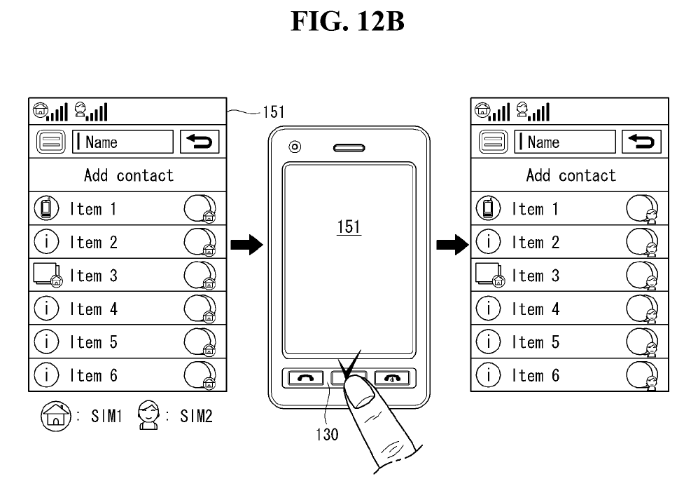

FIG. 9 illustrates switching an identity module according to an embodiment of the present invention. FIGS. 10A to 12B illustrate manipulating a user interface according to the method described in FIG. 9. In the present embodiment, a bundle conversion button may be disposed on the front case 101, the rear case 102, or a side wall, as shown in FIGS. 11 to 12B. The bundle conversion button may be embodied in various forms, for example, an icon displayed on a touch screen and a keypad, a dome switch, and a touch pad that can emit light using a light emitting diode (LED).

Referring to FIGS. 9 to 12B, the controller 180 determines a touch input (S91). The controller 180 determines whether a flicking touch action is performed in one item displayed on a touch screen by a hand or a stylus pen in a vertical direction, or a preset bundle conversion button is touched by the user (S92), the preset bundle conversion button being one of the user input unit 130. If the user performs the flicking touch action on a touch screen in which an UI is displayed as shown in FIGS. 10A and 10B, or if the user touches the preset bundle conversion button, as shown in FIGS. 11 to 12B, the controller 180 determines the flicking touch action or the touch of the bundle conversion button as a bundle conversion instruction for entire items and switches identity modules of entire items of a list displayed on the touch screen in a bundle or all together at once (S93).

The bundle conversion includes simultaneously switching an identity module of each item to an identity module that is different from the previously set identity module, as shown in FIG. 10A or 11. The bundle conversion further includes simultaneously switching identity modules of entire items to the same identity module, as shown in FIGS. 10B, 12A, and 12B. The mobile terminal 100 may provide a selection menu for a bundle conversion to a user setting menu such that the user may select one of the two bundle conversion methods described above in the user setting menu. Alternatively, the selection menu may be used by the user to select a different bundle conversion method, the flicking touch or the bundle conversion button touch.

The controller 180 determines whether an instruction icon displayed at the right side of a corresponding item, i.e. an icon of a house or a person is touched by the user (S94), as shown in FIGS. 10A to 12B. If the instruction icon is touched by the user, the controller 180 executes an instruction of the touched item (S95). For example, if the touched item is a phone number item, the controller 180 connects to the mobile communication network and executes audio dedicated communication or audiovisual communication, and if the touched item is a message item, the controller 180 executes a message transmission menu or an e-mail transmission menu according to user selection.

Since a cursor is not displayed on a display screen of a one touch phone, a specific position of the screen cannot be designated and thus an identity module may not be switched at a specific item. In such a one touch phone, identity modules of entire items can be switched by executing of the bundle conversion as described in FIGS. 9 to 12B. The embodiment exemplified in FIGS. 9 to 12B can be applied to the mobile terminal 100 in combination with the embodiments exemplified in FIGS. 3-8.

According to a method of switching an identity module and a mobile terminal using the same described above, a touch input for switching the identity module and a touch input for immediately executing an instruction without switching the identity module are distinguished. Therefore, the user can easily switch the identity module by entering the touch input that is specifically directed to switching the identity module, thus optimizing a user interface for switching the identity module.

In a mobile terminal according to the present invention, switching an identity module can be executed through software. When executing the switching through the software, operations relating to the above described embodiments may be implemented in code segments. A program or code segments may be stored in a processor readable medium, or be transmitted by a computer data signal coupled to a carrier wave in a transmission medium or a communication network.

The process of switching an identity module described above can be recorded and provided in a computer readable recording medium with a computer executable program. The computer readable recording medium includes all kinds of recording devices in which data that can be read by a computing system are stored. The computer readable recording medium includes, for example, a ROM, a RAM, a CD-ROM, DVD-ROM, DVD-RAM, a magnetic tape, a floppy disk, a hard disk, and an optical data storage device. Further, the computer readable recording medium is distributed to a computer system connected to a network, and a computer readable code is stored and executed with a distribution method.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for switching an identity module in a mobile terminal having a touch screen, the method comprising:
displaying a list comprising a plurality of service items on the touchscreen;
indicating an assigned identity module, of a plurality of identity modules, for each of the plurality of service items; and
switching the assigned identity module of a first service item of a plurality of service items to a different one of the plurality of identity modules responsive to a first touch input that is associated with the first service item.

2. The method of claim 1, further comprising:
receiving the first touch input responsive to detecting a touching object relative to the first service item for a threshold time period.

3. The method of claim 1, wherein the first touch input comprises at least one of a dragging touch input and a flicking touch input.

4. The method of claim 1, further comprising:
executing an operation related to the first service item responsive to receiving a second touch input.

5. The method of claim 1, further comprising:
switching the assigned identity module of all of the plurality of service items responsive to receiving a second touch input.

6. The method of claim 5, wherein the second touch input comprises a flicking touch input which corresponds to a sequentially displayed at least two of the plurality of service items.

7. The method of claim 1, further comprising:
receiving an input via an external key; and
switching the assigned identity module of all of the plurality of service items responsive to receiving the input via the external key.

8. The method of claim 1, further comprising:
switching the assigned identity module of all of the plurality of service items responsive to receiving a touch input at a second preset input.

9. The method of claim 8, wherein the second preset input comprises a flicking touch input which corresponds to a sequentially displayed at least two of the plurality of service items.

10. The method of claim 1, further comprising:
receiving an input via an external key; and
simultaneously switching all of the plurality of identity modules to a same identity module responsive to receiving the input via the externally key.

11. The method of claim 4, wherein the list comprises one of a communication path list, a message transmission path list, or an e-mail path list; and the operation comprises one of a communication execution, a message transmission menu execution, or an e-mail transmission menu execution.

12. A method of switching an identity module in a mobile terminal having a touch screen, the method comprising:
displaying a list comprising a plurality of service items on the touch screen;
indicating an assigned identity module, of a plurality of identity modules, for each of the plurality of service items;
switching the assigned identity module of a first service item of the plurality of service items to a different one of the plurality of identity modules responsive to a first touch input that is associated with the first service item; and
executing an operation related to the first service item responsive to receiving a second touch input.

13. A mobile terminal comprising:
a plurality of identity modules;
a touch screen configured to display a list comprising a plurality of service items, the list indicating an assigned identity module, of the plurality of identity modules, for each of the plurality of service items; and
a controller configured to switch the assigned identity module of a first service item of the plurality of service items to a different one of the plurality of identity modules responsive to a first touch input that is associated with the first service item.

14. The mobile terminal of claim 13, wherein the first touch input is responsive to detecting a touching object relative to the first service item for a threshold time period.

15. The mobile terminal of claim 13, wherein the first touch input comprises at least one of a dragging touch input and a flicking touch input.

16. The mobile terminal of claim 13, wherein the controller is further configured to execute an operation related to the first service items responsive to receiving a second touch input.

17. The mobile terminal of claim 13, wherein the controller is further configured to switch the assigned identity module of all of the plurality of service items responsive to receiving a second touch input.

18. The mobile terminal of claim 17, wherein the second touch input comprises a flicking touch input which corresponds to a sequentially displayed at least two of the plurality of service items.

19. The mobile terminal of claim 13, further comprising:
an external key configured to receive an input,
wherein the controller is further configured to switch the assigned identity module of all of the plurality of service items responsive to receiving the input via the external key.

20. The mobile terminal of claim 13, wherein the controller is further configured to switch the assigned identity module of all of the plurality of service items responsive to receiving a touch input at a second preset input.

21. The mobile terminal of claim 20, wherein the second preset input comprises a flicking touch input which corresponds to a sequentially displayed at least two of the plurality of service items.
